(19) United States
(12) Patent Application Publication
(10) Pub. No.: US 2016/0160912 A1
(43) Pub. Date: Jun. 9, 2016

(54) JOURNAL BEARING FOR UNIVERSAL JOINTS AND METHOD FOR PRODUCING A JOURNAL BEARING

(71) Applicant: Schaeffler Technologies AG & Co. KG, Herzogenaurach (DE)

(72) Inventor: Sven Lachnit, Herzogenaurach (DE)

(73) Assignee: Schaeffler Technologies AG & Co. KG, Herzogenaurach (DE)

(21) Appl. No.: 14/957,990

(22) Filed: Dec. 3, 2015

(30) Foreign Application Priority Data
Dec. 3, 2014 (DE) 102014224751.9

(51) Int. Cl. F16C 21/00; F16C 43/02; F16C 33/66; C21D 1/06; C21D 9/40; F16C 33/58; F16C 33/64; F16C 43/08

(52) U.S. Cl. CPC F16C 21/005; F16C 33/64; F16C 43/02; F16C 43/08; C21D 1/06; C21D 9/40; F16C 33/588; F16C 33/6603

(57) ABSTRACT

A journal bearing for universal joints, including a universal joint sleeve, roller-like rolling bodies, and a thrust washer is provided. A method for producing a journal bearing is also provided.

### INCORPORATION BY REFERENCE

The following documents are incorporated herein by reference as if fully set forth: German Patent Application No. 102014224751.9, filed Dec. 3, 2014.

### FIELD OF THE INVENTION

The invention relates to a journal bearing for universal joints, including a universal joint sleeve, roller-like rolling bodies, and a thrust washer. The invention further includes a method for producing a journal bearing.

### BACKGROUND OF THE INVENTION

Such a journal bearing is described in DE 195 10 761 A1. The journal bearing, also designated as a universal joint sleeve, is formed in one piece from a base and from a hollow cylindrical base body adjacent to the base. The journal bearing has, on the opening side, an edge that is formed on the universal joint sleeve and with which a thrust washer and rolling body are held axially in the universal joint sleeve.

Universal joint sleeves are usually formed from steel through cold-forming processes. As a result, a cup-shaped sleeve is produced that has a hollow cylindrical base body. One end of the base body is closed by the base. The other end is an open end of the sleeve on which, at this stage, the subsequent edge is formed in the shape of an extension. The wall thickness of the hollow cylindrical wall of the base body is reduced at the extension by a drawing stage, so that the extension can be turned over at a later time as a radially inward edge. The sleeve with the extension is hardened overall after the shaping process, so that the roller raceway provided on the inner circumference of the sleeve gains the necessary hardness for a rolling contact with rolling bodies.

The insertion of the thrust washer and the rolling body in the sleeve provides for the installation of the journal bearing. The opening cross section of the open end of the sleeve is specified by its inner diameter and expanded by the drawing stage so that the components can be inserted easily. After inserting the components into the sleeve, the extension of the base body should be turned over radially inward far enough that the components are held by the edge in the universal joint sleeve in the axial direction. This turning-over process is commonly also called rolling or flanging by those skilled in the art.

As can be seen from FIGS. 3 and 4 of DE 195 10 761 A1, after the turning-over process, the edge extends inward in the direction of the axis of symmetry of the universal joint sleeve so far that the diameter of the opening cross section defined by the edge is smaller than the outer envelope circle of the rolling body. In this way, the rolling bodies are held by the edge in the universal joint sleeve. The washer is large enough so that at least its outer diameter is greater than the inner envelope circle of the rolling bodies. The rolling bodies hold the thrust washer in position between themselves and the base. The outer envelope circle of the rolling body is to be understood in this case as the inner diameter of the outer roller raceway of the universal joint sleeve, which the rolling bodies contact. The inner envelope circle corresponds, in FIGS. 3 and 4 of DE 195 10 761 A1, to the outer diameter of the universal joint journal.

To be able to turn over the edge at all, the material at this position must not exceed a certain hardness. The problem is thus that the extension must be hardened just like the sleeve, but due to the shaping of the edge, it should not be hardened like the other areas of the universal joint sleeve. Turning over a hardened extension at the edge could produce cracks in the hardened material.

This problem mentioned above has been previously solved for journal bearings of the prior art according to the example of a needle sleeve described in DE 100 20 118 A1. Following the actual annealing process that is integrated in the case-hardening method for strain relief of the microstructure and that the entire sleeve is subjected to, a separate annealing process is performed only on the extension, e.g., through inductive annealing. In this way, the case-hardened material of the extension becomes soft again and can be flanged to form the edge. This means a separate processing step in which each of the sleeves must be received and annealed individually. The complexity for producing such a journal bearing and the production costs are therefore high. The additional heat entry into the universal joint sleeve can negatively affect the dimensional accuracy and shape accuracy. In addition, the risk of crack formation in the flange area is not avoided.

### SUMMARY

The objective of the invention is to create a journal bearing that can be produced easily and economically.

This objective is achieved through one or more features of the invention as described below and in the claims.

The final journal bearing is described essentially by the combination of the following features:
The final edge of the universal joint sleeve is hardened just like its base body, wherein the base body and the inner and outer edge of the universal joint sleeve together have a hardened surface on the surface of the base body and the edge;
The final edge of the universal joint sleeve, i.e., the edge turned over in the direction of the rotational axis of the journal bearing or in the direction of the axis of symmetry of the universal joint sleeve, defines an opening with an opening cross section whose diameter is less than the outer diameter of the thrust washer sitting in the universal joint sleeve; and
The thrust washer is shaped elastically and pliantly such that the largest outer dimensions can be reduced elastically to at least the diameter of the opening.

The whole universal joint sleeve according to the invention, including the flanged edge, has a hardened surface. This surface advantageously has, as one construction of the invention provides, a surface hardness of at least 700 HV1 corresponding to the requirements for the hardness of roller raceways. In this way, the journal bearing differs from the journal bearings of the prior art. As already mentioned, the flanged edge of the journal bearing of the prior art is soft.

The advantage of the invention lies in that the journal bearing can be installed immediately after the case hardening of the universal joint sleeve. The additional partial annealing of the extension after the case hardening is no longer necessary. The production costs of a universal joint sleeve according to the invention and accordingly also those for producing the journal bearing are reduced. The final universal joint sleeve is constructed more precisely. There is no longer any risk of cracks in the flange area. Because the thrust washer is elastic, its outer dimensions can be reduced during or even before its insertion into the universal joint sleeve through snapping in, folding, radial pretensioning, bending, etc., at least so that the thrust washer can be inserted into the universal joint sleeve. In the universal joint sleeve, the thrust washer springs back elastically in the radial direction and assumes its original shape again. The material and/or the shape of the thrust washer have an elastic construction for this purpose.

A method for producing a journal bearing provides the following steps:
a. Forming of a cup-shaped sleeve from a flat original material, so that it has a hollow cylindrical base body and one end of the base body is closed by the base, wherein the open end of the sleeve has an extension, advantageously through cold forming;
b. At the same time or after step a.: Forming of the universal joint sleeve, in that the edge is formed by flanging or rolling the hollow cylindrical section (the extension) about the opening cross section;
c. Hardening of the universal joint sleeve through case hardening;
d. Installing the journal bearing after step c., wherein initially the thrust washer is brought into a shape fitting into the opening cross section through elastic deformation. The thrust washer is inserted simultaneously or afterward through the opening cross section into the universal joint sleeve. Then the rolling bodies are inserted into the universal joint sleeve.
e. Optional: Introducing lubricating grease before, during, or after the insertion of the rolling bodies into the universal joint sleeve.

The rolling bodies are rollers or needles. Rollers and needles have a cylindrical base body that can deviate, however, from the cylindrical shape through crowned running surfaces and end sides. Needles are differentiated from rollers in terms of their ratio of length to diameter, wherein this ratio is greater than or equal to 2.5 for needles and is less than 2.5 for rollers.

As steel materials, advantageously materials with good cold-forming properties are used. Because these can be hardened not at all or only poorly due to their low carbon content, case hardening is provided as the preferred hardening method. Case hardening is understood to be carbonization in atmospheres releasing carbon (such as salt baths, gas, or powder) with subsequent treatment leading to hardening (such as quenching) and usually with subsequent annealing of the universal joint sleeve. During carbonization, carbon diffuses into an edge layer starting from the surface. In this way, the carbon content of the steel in the edge layer increases. Then hardening is realized through quenching. This can be performed on the sleeve at the temperature of the sleeve after the carbonization. Alternatively, the sleeve is heated and quenched at a material-specific hardening temperature. The annealing is used first for eliminating strain in the microstructure. The results of the hardening method are a hard edge layer that withstands the rolling contact with the rolling bodies under all operating conditions and a ductile core of the universal joint sleeve wall. Alternatively, carbonitriding is provided as thermochemical case hardening in which, in addition to carbon, nitrogen is also diffused into the edge layer. The hardness here advantageously corresponds to a value of 700 HV1 CHD₅₅₀ measured according to the known Vickers method.

700 HV1 stands for a hardness of the edge layer and this advantageously with a case-hardness depth CHD₅₅₀ of 0.1 to 0.2 mm below the surface. The case-hardness depth (CHD) is the perpendicular distance from the surface of a workpiece to a defined Vickers hardness HV1=550, which is subject to the standard hardness testing at specified test conditions according to the known Vickers method. The value of 700 HV1 corresponds to a required hardness for raceways of roller bearings.

### BRIEF DESCRIPTION OF THE DRAWINGS

The foregoing Summary and following Detailed Description will be best understood when read in conjunction with the drawings, in which:

FIG. 1 shows a cross-sectional view through an embodiment of a journal bearing;

FIG. 2 shows an enlarged detail indicated by area X in FIG. 1; and

FIG. 3 shows a greatly enlarged detail of areas Y and ZS in FIG. 2.

### DETAILED DESCRIPTION OF THE PREFERRED EMBODIMENTS

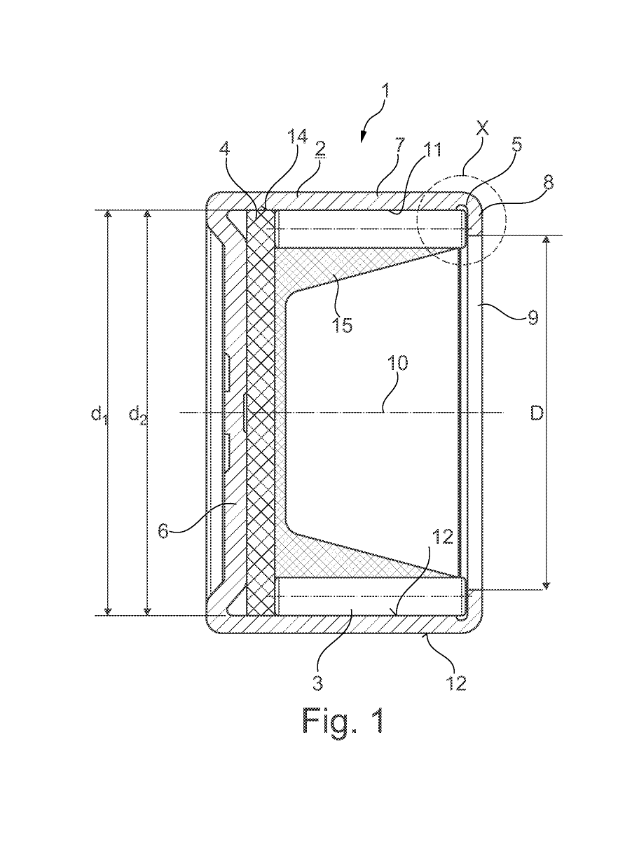

FIG. 1 shows, in a longitudinal section along an axis of symmetry 10, an embodiment of a journal bearing 1 for universal joints, not drawn to scale, including a universal joint sleeve 2, roller-like rolling bodies 3, and a thrust washer 4. The universal joint sleeve 2 has a base 6, a hollow cylindrical base body 7 adjacent to the base 6, and an edge 8. The edge 8 borders a round opening 9 opposite the base 6. The base 6, the base body 7, and the edge 8 are formed from steel in one piece. It is also conceivable that the floor is inserted separately.

The edge 8 is turned over at a deformation zone 5 radially inward relative to the axis of symmetry 10 such that the opening 9 bordered on the circumferential side by the edge 8 has an opening cross section with an opening diameter D. The opening diameter D is smaller than an inner diameter d₁ of the roller raceway 11 describing the base body 7 on the inside. The rolling bodies 3 are arranged in the interior of the base body 7 on the roller raceway 11 on the circumferential side. The thrust washer 4 sits axially between the base 6 and the rolling bodies 3 and has an outer cylindrical shape. The journal bearing 1 is filled with an amount of lubricating grease 15.

On its outer cylindrical surface 14, the thrust washer 4 has an outer diameter d₂ that is larger than the opening diameter D. However, the thrust washer 4 can be deformed in an elastically flexible way into dimensional changes through bending, folding, or other means, so that it can be inserted through the opening 9 into the universal joint sleeve 4 for the installation of the journal bearing 1.

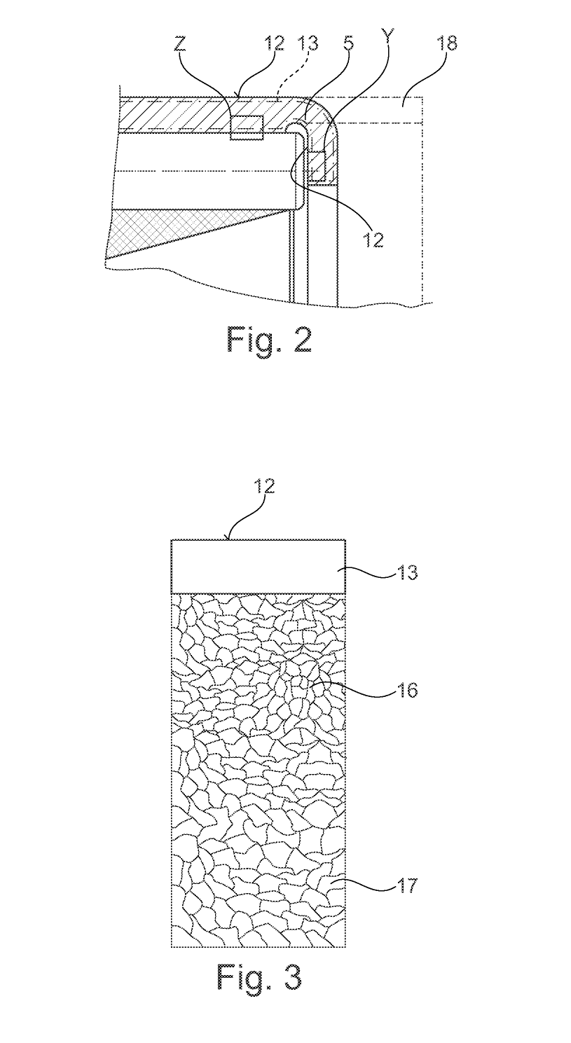

In FIG. 2, the detail X from FIG. 1 is shown enlarged. The finished universal joint sleeve 2 has, on the surface 12, on the inside and also outside of the base body 7 and also the edge 8, a hardened edge layer 13 that is shown graphically in FIG. 2 with a dash-dot-dot line. The extension 18 is shown with dashed lines and is turned over and deformed to produce the edge 8 at the deformation zone 5 before the hardening of the universal joint sleeve 2.

In FIG. 3, greatly enlarged examples of microscopic sections of the micro-structures of the universal joint sleeve 2 wall are shown with reference to the sections Z of the roller raceway 11 and Y at the edge 8. From FIG. 3 it can be seen that, in the universal joint sleeve 2, at least on the inside on the roller raceway 11 and on the edge 8, an edge layer 13 is formed that is adjacent to a transition zone 16 and the ductile core 17 of the universal joint sleeve 2 wall. The edge layer 13 has a hardness of 700 HV1.

### REFERENCE SYMBOLS

1 Journal bearing
2 Universal joint sleeve
3 Rolling body
4 Thrust washer
5 Deformation zone
6 Base
7 Base body
8 Edge
9 Opening
10 Axis of symmetry
11 Roller raceway
12 Surface
13 Edge layer
14 Surface
15 Lubricating grease
16 Transition zone
17 Core
18 Extension

1. A journal bearing for universal joints, comprising: a universal joint sleeve, rolling bodies, and a thrust washer,
the universal joint sleeve includes a base, a hollow cylindrical base body adjacent to the base, an edge, and an opening, the edge is formed from steel in one piece with the base body and extends from the base body in a radial direction inward at an angle to an axis of symmetry of the base body such that the opening bordered on a circumferential side by the edge has an opening cross section with an opening diameter (D) that is smaller than an inner diameter (d₁) of the base body,
the rolling bodies are distributed on the circumferential side on an inside on the base body on a roller raceway,
the thrust washer is arranged axially between the base and the rolling bodies and has an external cylindrical shape, as well as an outer diameter (d₂) that is larger than the opening diameter (D), and
the base body and the edge together have a hardened surface on an inside and an outside of the universal joint sleeve on a surface of the base body and the edge, and the thrust washer has an elastic construction with a shape that is deformable elastically to a cross section that is equal to or less than the opening cross section defined by the opening diameter (D).

2. The journal bearing according to claim 1, wherein at least the surface has, at least on the roller raceway, a surface hardness of at least 700 HV1.

3. A method for producing a journal bearing according to claim 1, comprising: forming the universal joint sleeve by shaping a cup-shaped sleeve that has a hollow cylindrical base body, a base, and a hollow cylindrical extension of the base body,
generating the edge with the opening cross section of the universal joint sleeve by turning over the extension,
finishing the universal joint sleeve, including the edge, by hardening, and
installing the journal bearing after the hardening, including elastically deforming the thrust washer until this fits through the opening cross section, and then inserting the thrust washer through the opening cross section into the universal joint sleeve and then inserting the rolling bodies into the universal joint sleeve.

4. The method according to claim 3, wherein the hardening comprises a case-hardening.
